(19) United States
(12) Patent Application Publication
(10) Pub. No.: US 2025/0324447 A1
(43) Pub. Date: Oct. 16, 2025

(54) MANAGEMENT OF LOW LATENCY TRAFFIC IN WLAN SYSTEMS

(71) Applicant: INTERDIGITAL PATENT HOLDINGS, INC., Wilmington, DE (US)

(72) Inventors: Hanqing LOU, Syosset, NY (US); Xiaofei WANG, North Caldwell, NJ (US); Ying WANG, Easton, PA (US); Rui YANG, Greenlawn, NY (US)

(21) Appl. No.: 18/632,123

(22) Filed: Apr. 10, 2024

(51) Int. Cl. H04W 72/566; H04W 84/12

(52) U.S. Cl. CPC H04W 72/566; H04W 84/12

(57) ABSTRACT

Methods and apparatuses are disclosed for a station (STA) in a Wireless Local Area Network (WLAN) to indicate its intent to transmit high priority traffic, such as low latency traffic, over a shared wireless medium. The transmission by a STA of a signal referred to as a Low Latency Traffic Indication (LLTI) signal and conditions for doing so are disclosed. An Access Point (AP) broadcasts LLTI management information relating to conditions subject to which STAs may transmit the LLTI signal and contend for the wireless medium for the purpose of transmitting low latency traffic. Information that may be included in the LLTI management information is disclosed. Multiple embodiments of methods and apparatuses are disclosed.

### CROSS-REFERENCE TO RELATED APPLICATIONS

This application is being filed on even date herewith with U.S. Patent Application No. ______, filed under Attorney Docket No. 2024P00234 US, and incorporated herein by reference in its entirety.

### BACKGROUND

A wireless local area network (WLAN) in Infrastructure Basic Service Set (BSS) mode has an Access Point (AP) for the BSS and one or more stations (STAs) associated with the AP. The AP typically has access or interfaces to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where a source STA sends traffic to the AP and the AP delivers the traffic to a destination STA. For certain kinds of traffic, referred to herein as “low latency traffic,” such as traffic for which it may be necessary or desirable to meet, for example, certain maximum delay, priority, and/or jitter requirements, it may be desirable to adopt latency management features in a WLAN.

### SUMMARY

One or more of the foregoing issues or needs may be addressed by aspects of the embodiments disclosed herein.

In certain aspects, embodiments of a method are disclosed for a station (STA), the method comprising: receiving, from an Access Point (AP), a first frame including management information relating to one or more conditions for managing transmission of high priority traffic over a wireless medium in a Wireless Local Area Network (WLAN); transmitting a second frame based on the management information; and transmitting high priority traffic over the wireless medium.

In certain aspects, embodiments of a STA are disclosed comprising a transceiver and a processor communicatively coupled to the transceiver, the transceiver and processor configured to: receive, from an AP, a first frame including management information relating to one or more conditions for managing transmission of high priority traffic over a wireless medium in a WLAN; transmit a second frame based on the management information; and transmit high priority traffic over the wireless medium.

In certain aspects, embodiments of a method are disclosed for an access point (AP), the method comprising: transmitting to a STA management information relating to one or more conditions for managing transmission of high priority traffic over a WLAN; receiving from the STA a second frame based on the management information; and receiving high priority traffic over the wireless medium.

Other aspects of a STA and methods therefor are disclosed that provide for performing a backoff procedure if it is determined that a transmission over the wireless medium during a backoff period following the transmission of the second frame has occurred.

In further disclosed aspects, the management information includes identification information identifying the management information as pertaining to high priority traffic; and one or more of: mode information indicating one or more modes in which the second frame may be transmitted, second frame transmission interval information, backoff information, transmission opportunity information, priority information, or length information indicating a length of the management information.

Additional aspects are also disclosed.

One or more embodiments also provide a computer program comprising instructions which when executed by one or more processors cause the one or more processors to perform the methods according to any of the embodiments described herein.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram of an example wireless local area network (WLAN) in which one or more disclosed embodiments may be implemented;

FIG. 3 shows an example of a low latency traffic indication element format used in a WLAN; and

FIG. 4 is a messaging diagram illustrating an example method according to one or more disclosed embodiments.

### DETAILED DESCRIPTION

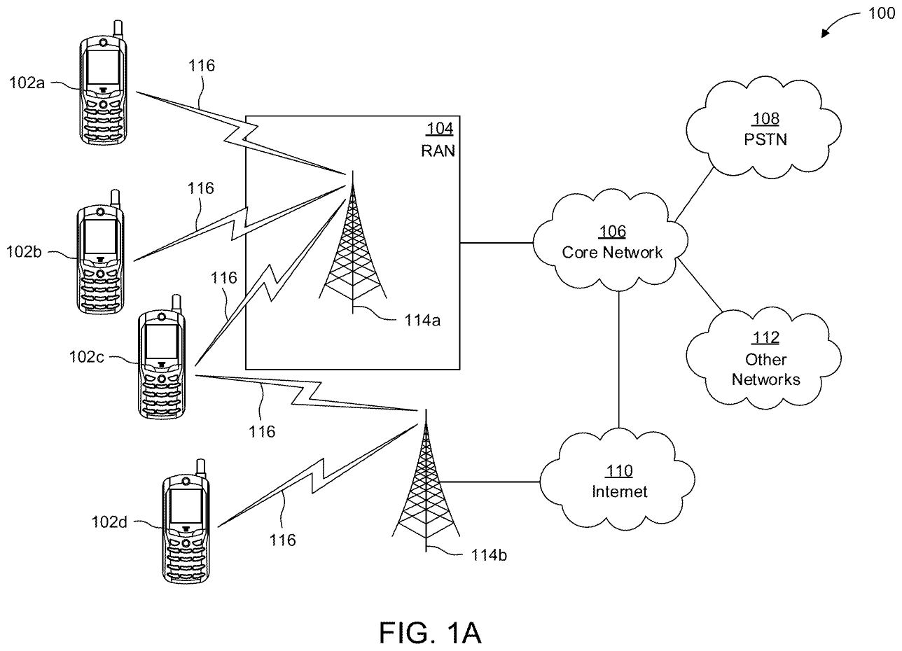

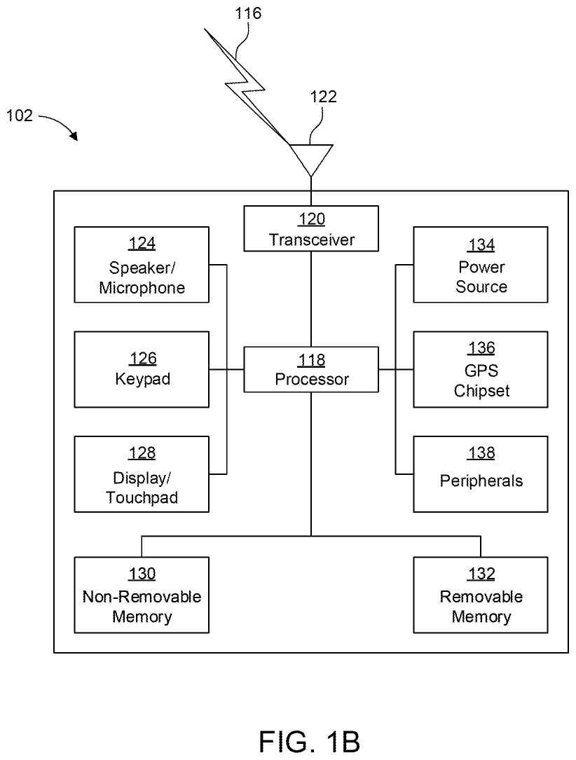

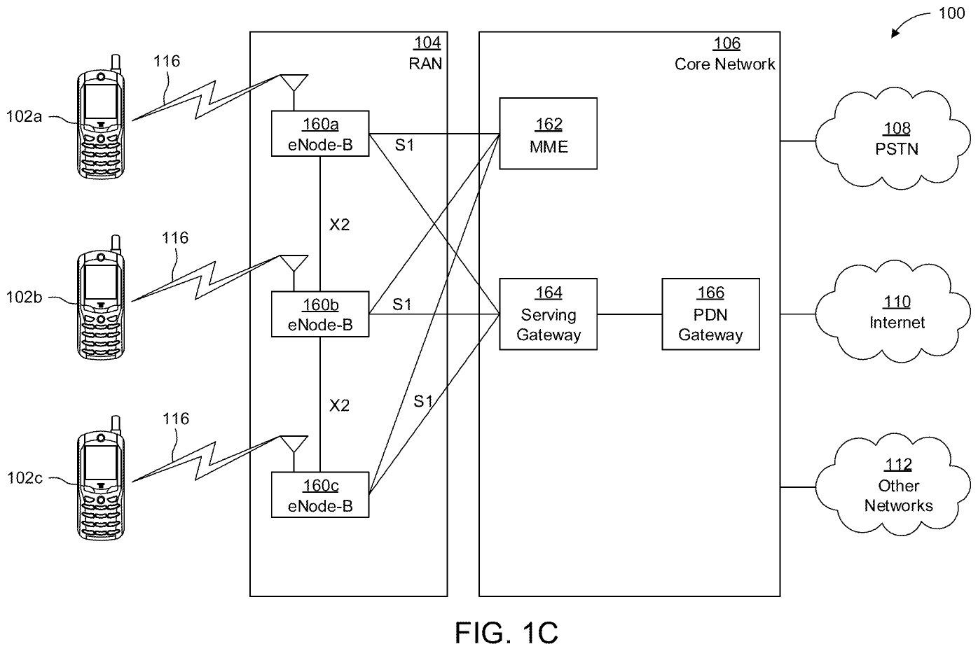

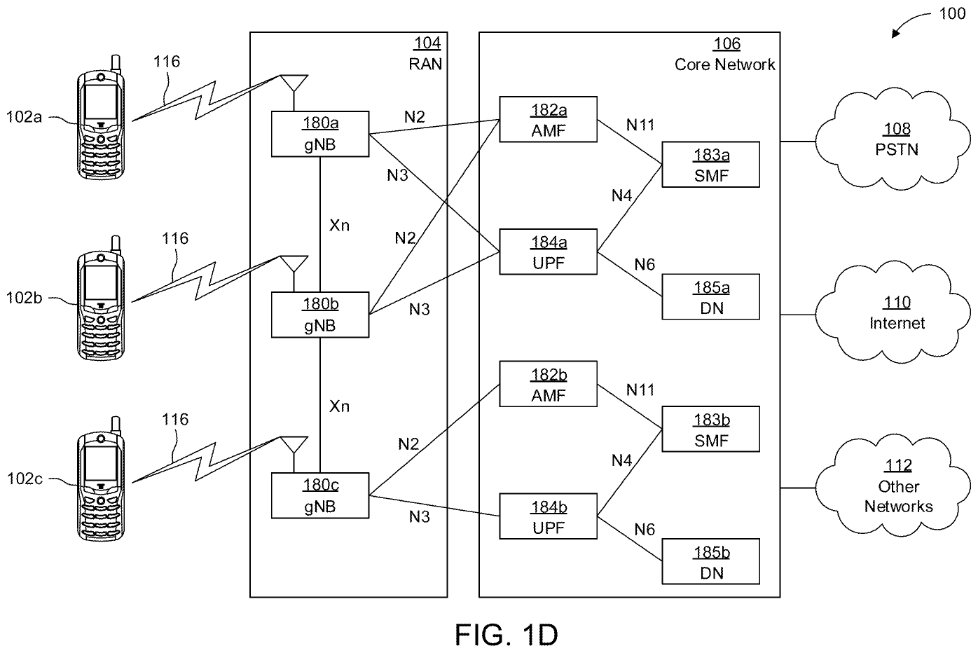

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor, a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHZ, 40 MHZ, 80 MHZ, and/or 160 MHz wide channels transmitted over a 5 GHz frequency band using OFDMA. The 40 MHZ, and/or 80 MHZ, channels may be formed by combining contiguous 20 MHz channels. A 160 MHz channel may be formed by combining 8 contiguous 20 MHZ channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHZ, 80 MHZ, and/or 160 MHz wide channels capable of transmission over 2.4 GHZ, 5 GHZ, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHZ and 6 GHZ) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability—UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave—IMMW), energy harvesting based on of WiFi RF signals for facilitating WLAN communications of low-power IoT devices, and the randomization of MAC addresses in WLANs.

### Low Latency Traffic Channel Access

According to existing channel access procedures, IEEE 802.11 stations (STAs) usually perform a random backoff procedure before transmitting for each contention period.

When a STA with a frame queued for transmission determines that the wireless medium is idle and the wireless medium remains idle for a period of a Distributed Inter-Frame Space (DIFS) or an Extended Inter-Frame Space (EIFS) from the end of the immediately preceding medium-busy event, the STA may invoke a random backoff procedure. The STA may start transmitting if the wireless medium remains idle after a backoff counter at the STA, which was set to a randomly chosen initial value, decrements down to 0. The backoff counter is set to an integer value chosen randomly with a uniform distribution between 0 to CW[AC], where CW is an integer value between aCWmin and aCWmax, and AC is an index corresponding to an access category (e.g., voice, video, best effort, background). aCWmin and aCWmax are values set by the AP. The STA (AP or non-AP) will set the initial value of CW to aCWmin. CW is doubled when a collision or transmission failure occurs but is capped by aCWmax. CW is reset to aCWmin after every successful transmission. If no medium activity is indicated for the duration of a particular backoff slot, then the backoff procedure shall decrement its backoff counter.

To support low latency traffic transmission, one approach is to allow STAs with low latency traffic to transmit a Defer Signal (DS) without backoff in a contention period. After the reception of Defer Signal transmitted from one or more STAs with low latency traffic, STAs without low latency traffic may hold their contention and wait for the next transmission opportunity (TXOP). If two or more STAs concurrently transmit the Defer Signal, they may start a backoff procedure in order to reduce the chance of collision.

A purpose of the Defer Signal (DS), or the like, is to give STAs with low latency traffic a chance to access the medium in an aggressive way, in that the transmission of the DS is without any backoff. Any aggressive STA, however, regardless of the type of traffic (low latency or not) it may have, can always transmit the DS at the beginning of a contention period. If there is one such aggressive STA in a BSS, it will always be able to occupy the medium whenever it wants. If there is a group of such aggressive STAs in a BSS, this group of STAs will always have a higher priority to access the medium than the other STAs in the BSS. If all the STAs in a BSS are aggressive STAs, then the situation is like traditional channel access, except that the DS is always transmitted, unnecessarily, and becomes an additional overhead for any contention period. Therefore, to give STAs with low latency traffic high priority to access the medium by using a DS, or the like, while still maintaining a certain degree of fairness among STAs in the network and preventing intentionally aggressive STAs from occupying the medium unnecessarily, a flexible control mechanism is desirable.

In a WLAN, it may be desirable that a STA with low latency traffic enjoy higher priority to access the wireless medium than a STA without low latency traffic. In representative embodiments in accordance with the present disclosure, a STA with low latency traffic can transmit such traffic with limited or no backoff by first transmitting a signal referred to herein as a Low Latency Traffic Indication (LLTI), LLTI signal, or LLTI frame. In representative embodiments, such as signal and its transmission can be implemented as described in U.S. Patent Application No. ______, filed on even date herewith under Attorney Docket No. 2024P00234 US, and incorporated herein by reference in its entirety.

More than one STA may transmit the LLTI concurrently. The LLTI may be transmitted without backoff. After the LLTI is transmitted, STAs which have low latency traffic and/or had transmitted the LLTI may be able to contend for the wireless medium. Limited backoff may entail using a backoff procedure with higher priority, and/or a lower backoff counter (e.g., lower Cmin/Cmax values), etc. After transmission of the LLTI, a STA may perform a backoff procedure, in which it randomly determines a backoff period, senses the wireless medium for any transmission activity thereon, and if in that backoff period does not sense any such activity, may then proceed to transmit its low latency traffic on the wireless medium.

A STA without low latency traffic or which has not transmitted the LLTI may withhold transmission after detecting transmission of an LLTI from other STA(s). For example, after it detects an LLTI, a STA without low latency traffic may defer its channel access.

The aforementioned procedures may be allowed in a certain period of time or duration, such, as for example, within a TXOP, within a beacon interval, or for any contention period, which may be given dynamically or semi-statically.

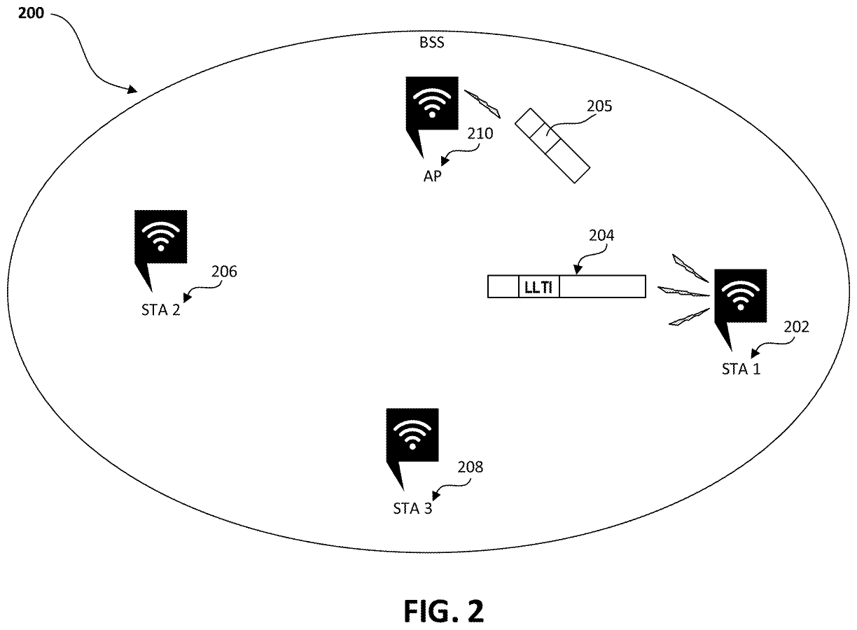

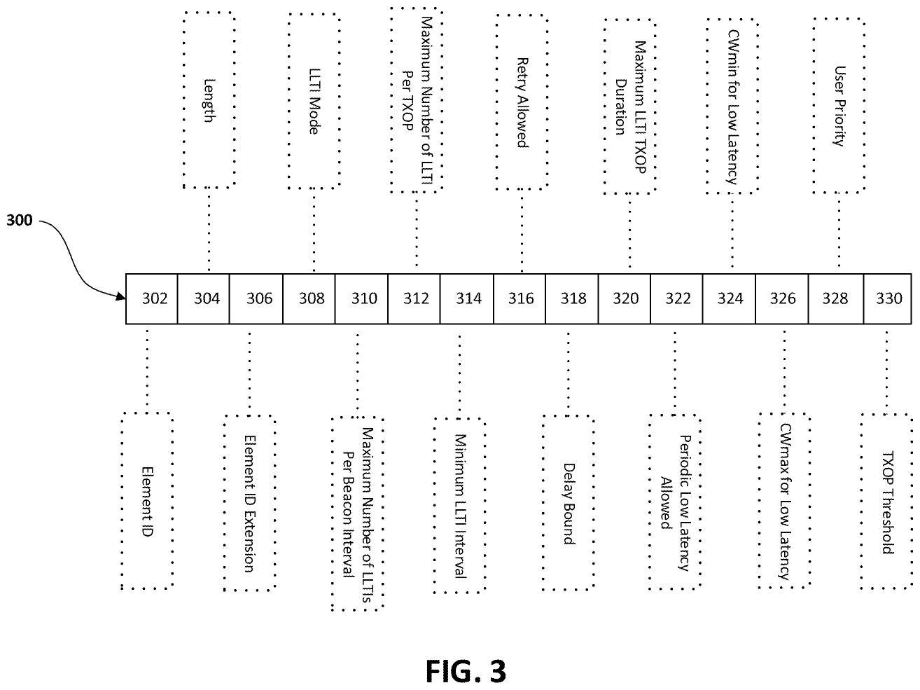

FIG. 2 shows an example WLAN 200 including a STA 202, a STA 206, a STA 208, and an AP 210. The WLAN 200 is in Infrastructure Basic Service Set (BSS) mode, with the STAs 202, 206, and 208 and the AP 210 considered to constitute a BSS. In the illustrative scenario depicted in FIG. 2, the STA 202 has transmitted an LLTI frame 204 to indicate its need to transmit low latency traffic and to inform non-low-latency transmitting STAs to defer transmission of their traffic. Transmission of the LLTI frame 204 is based on an LLTI element 205 received from, for example, AP 210. LLTI element 205 is described in greater detail below with reference to FIG. 3. As described in the following, element 205 provides one or more conditions for managing the transmission of low latency traffic by facilitating and managing the transmission of the LLTI frame 204.

### The LLTI Management Field/Subfield/Element

In representative embodiments in accordance with the present disclosure, a new LLTI management field/subfield/element to carry LLTI-related information is provided. A representative LLTI management element 300 is shown in FIG. 3, having one or more subsets or all of multiple fields 302-330, which will now be described in greater detail. LLTI management element 300 can act as LLTI element 205 transmitted from AP 210, as depicted in FIG. 2.

An Element ID field 302 may be used to indicate that the element is an LLTI management element, and an Element ID Extension field 306 may be used to indicate additional information about the LLTI management element 300.

A Length field 304 is used to indicate the length of the LLTI management element 300.

An LLTI Mode field 308 may be used to indicate one or more scenarios or modes in which the LLTI signal (such as represented by LLTI frame 204 shown in FIG. 2) may be allowed to be transmitted. For example, Mode 1 may indicate that the LLTI signal may be transmitted in a TXOP. Mode 2 may indicate that the LLTI signal may be transmitted in a TXOP initiated by the AP. Mode 3 may indicate that the LLTI signal may be transmitted in any contention period, etc. In the case that only one mode is allowed, this field may be omitted, and the mode may be predefined.

A Maximum number of LLTIs per Beacon Interval (BI) field 310 may be used to indicate the number of LLTI signals (e.g., 0, 1, 2, . . . ) allowed per STA per beacon interval. In representative embodiments, different Access Categories (ACs), Traffic Identifiers (TIDs), or other types of traffic priority categories may have different maximum allowed numbers of LLTI signals per BI. In such a case, multiple values, each corresponding to a traffic priority category, may be included in this field.

A Maximum number of LLTIs per TXOP field 312 may be used to indicate the number of LLTI signals allowed per STA per TXOP. In representative embodiments, different ACs, TIDs, or other types of traffic priority categories may have different maximum allowed numbers of LLTI signals per TXOP. In such a case, multiple values, each corresponding to a traffic priority category, may be included in this field.

A field 314 containing a Minimum LLTI Interval may be used to indicate the minimum interval required between two consecutive LLTI signals transmitted from a STA, or a non-AP STA. In representative embodiments, different ACs, TIDs, or other types of traffic priority categories may have different minimum LLTI interval requirements. In such a case, multiple values may be included in this field, with each value corresponding to a traffic priority category.

A Retry Allowed field 316 may be used to indicate if channel access by use of the LLTI is allowed for the first transmission, second transmission, up to a k-th transmission of a MAC packet, or any combination of the numbers [1, k] of transmissions, k being a maximum number of transmissions. This field may be in the form of a bitmap, for example, with each bit corresponding to a retry index, where the nth bit indicates if use of an LLTI signal is allowed for the (n-1)th transmission. As an illustrative example, a bitmap of 0010 indicates that an LLTI signal may be used for the third transmission, but it may not be used for the first, second, or fourth transmission of a packet. For those transmissions, channel access that does not use the LLTI may be used instead. Field 316 may also be in the form of a natural number, for example, m, where m indicates the use of an LLTI signal is only allowed for the mth transmission onwards after failing the first m-1 transmissions. The information in field 316 can be characterized as a type of priority information, which relates to conditions for which priority transmission, as described herein, may be available.

A Delay Bound field 318 may be used to indicate a threshold of delay bound of traffic for which channel access by use of the LLTI may be allowed, i.e., if a STA has traffic with delay bound smaller than the threshold, the STA may use an LLTI signal for transmission of its traffic. A special value in the Delay Bound field 318 may be used to indicate that no threshold is used and that use of the LLTI signal is allowed for traffic with any delay bound. The information in field 318 can be characterized as a type of priority information, which relates to conditions for which priority transmission, as described herein, may be available.

A Maximum LLTI TXOP Duration field 320 may be used to indicate the maximum allowed TXOP duration a STA could set after gaining access to the wireless medium using an LLTI signal. As used herein, “LLTI TXOP” refers to a transmission opportunity acquired through LLTI-based channel access. Setting this field to a special value (e.g., 0) may be used to indicate that there is no maximum duration limit for an LLTI TXOP. Alternatively, a Maximum LLTI PPDU Length/Duration field may be used instead of or additionally. Such a field may be used to indicate a maximum allowed LLTI PPDU length or duration. Setting this field to a special value (e.g., 0) may be used to indicate that there is no maximum PPDU limit for LLTI access.

A Periodic Low Latency Allowed field 322 may be used to indicate whether LLTI-based channel access is allowed and/or suggested for periodic low latency traffic. The information in field 322 can be characterized as a type of priority information, which relates to conditions for which priority transmission, as described herein, may be available. For example, under one condition, field 322 may indicate that LLTI-based channel access is permitted for periodic low latency traffic, while under another condition field 322 may indicate that LLTI-based channel access is permitted for only non-periodic low latency traffic. In some instances, field 322 may also indicate LLTI-based channel access allowance based a predefined threshold of how often periodic low latency traffic is available for transmission. If the periodic availability meets and/or exceeds the threshold, LLTI-based channel access is permitted.

A CWmin for Low Latency field 324 may be used to indicate an LLCWmin value to be used as the lower bound for an LLCW value for LLTI-based access. The LLCW value defines the range in which a STA may choose the backoff counter randomly. In other words, the STA may initialize an LL backoff counter with a randomly selected value in the range of [0, LLCW]. An STA may, for example, start with an LLCW value equal to LLCWmin, and, depending on the detailed channel access scheme, the STA may double or keep the LLCW value unchanged after a transmission failure. After a transmission success, the STA may reset the LLCW value to LLCWmin. In representative embodiments, different ACs, TIDs, or other types of traffic priority categories may have different LLCWmin values. In such a case, multiple values may be included in this field, with each value corresponding to a traffic priority category.

A CWmax for Low Latency field 326 may be used to indicate an LLCWmax value to be used as the upper bound for the LLCW value for LLTI-based access. In other words, the maximum value LLCW a STA could set is LLCWmax. In representative embodiments, different ACs, TIDs, or other types of traffic priority categories may have different LLCWmax values. In such a case, multiple values, each corresponding to a traffic priority category, may be included in this field.

In representative embodiments, the CWmin for Low Latency and CWmax for Low Latency fields 324 and 326, respectively, may contain the same value. In such a case, the LLCW value is set to this value and it is not adjusted based on transmission results (i.e., success or failure).

A User Priority field 328 may be used to indicate a priority threshold. A STA with user priority greater than this threshold may be allowed to transmit an LLTI signal. The information in field 328 can be characterized as a type of priority information, which relates to conditions for which priority transmission, as described herein, may be available.

A TXOP Threshold field 330 may be used to indicate a TXOP threshold value T. STAs may be allowed to transmit an LLTI signal within a TXOP when the TXOP duration is greater than T, as specified in this field.

The LLTI management element 300 may be carried in a management frame, such as for example, a Beacon frame, a Probe Response frame, a (Re) Association Response frame, etc.; in an existing or new action frame; or in an existing or new control frame.

While the representative LLTI management element 300 is described in the format of an element, the same or equivalent information described as included in LLTI management element 300 can be provided in any other suitable format, such as for example, in a sub-element, field, or sub-field. Moreover, the LLTI information described may be carried in different elements, sub-elements, fields, sub-fields, and/or frames, and in different orders, structures, and/or arrangements.

In the case that multi-link operation is supported, an AP affiliated with an AP Multi-Link Device (MLD) (e.g., reporting AP) may announce the LLTI element for another AP affiliated with the same AP MLD (e.g., reported AP). To enable this, the LLTI element may be carried or included in an element, such as, for example, a Multi-Link element, an ML Re-configuration element, a Reduce Neighbor Report element, etc. A change in the LLTI element may cause an increase of the BSS Parameters Change Count subfield in the Beacon or it may cause the Critical Update Flag field in the Beacon to be set, thereby indicating that a critical update has happened for the corresponding reported AP.

### Restricting Potential Improper Use of the LLTI

In representative embodiments, the management of low latency transmissions may also entail measures so as to minimize or avoid negative impacts for STAs that do not have low latency traffic or for STAs, such as legacy STAs, that may not transmit or fully understand the LLTI signal.

In representative embodiments, transmission of an LLTI signal may be restricted. For example, a STA may be allowed to transmit an LLTI signal up to N times per Beacon Interval, where N is a natural number (e.g., 1, 2, 3, . . . ). In representative embodiments, N may be predefined or it may be chosen by an AP and signaled through a broadcast frame, such as a Beacon frame, or through a frame during the association process. The number N can be indicated in the Maximum Number of LLTIs per BI field 310, described above with reference to FIG. 3. As described above, different Access Categories (ACs), Traffic Identifiers (TIDs), or other types of traffic priority categories may have different values for N.

A STA may be allowed to transmit an LLTI signal up to M times per TXOP, where M is a natural number. In representative embodiments, M may be predefined or it may be chosen by an AP and signaled through a broadcast frame, such as a Beacon frame, or through a frame during the association process. The number M can be indicated in the Maximum Number of LLTIs per TXOP field 312, described above with reference to FIG. 3. As described above, different values for M may be used for different ACs, TIDs, or other types of traffic priority categories.

A STA may be allowed to transmit an LLTI signal only after a certain time interval from its last successful transmission by use of an LLTI signal. The Minimum LLTI Interval field 314 shown in FIG. 3 may indicate the minimum interval required between two consecutive LLTI signals transmitted from a STA, or a non-AP STA. In other words, a STA or a non-AP STA may need to wait at least the Minimum LLTI Interval from the end of its last LLTI signal transmission to transmit a new LLTI signal.

A STA may be allowed to transmit an LLTI signal if its low latency traffic meets certain requirements. For example, if the delay bound of a STA's low latency traffic is within a predefined period, or the length (in number of e.g., bits or bytes) of the low latency traffic is within a certain defined range, the STA may be allowed to transmit an LLTI signal. The Delay Bound field 318 described above with reference to FIG. 3 may indicate the delay bound threshold. If a STA has traffic for which the delay bound is less than the delay bound threshold, it may be allowed to transmit an LLTI signal.

A STA may be allowed to transmit an LLTI signal for the first transmission of its low latency traffic. A STA may be allowed to transmit an LLTI signal for the retransmission of its low latency traffic, such as indicated by the Retry Allowed field 316.

A STA with at least a minimum User Priority, such as indicated in field 328 described above, may be allowed to transmit an LLTI signal.

For a STA with periodic low latency traffic, other methods such as Target Wake Time (TWT) or restricted TWT (rTWT) may be suggested by the AP for delivery of the STA's traffic. Such a suggestion can be indicated in the Periodic Low Latency Allowed field 322 of the LLTI. In representative embodiments, STAs which support rTWT may not be allowed to transmit an LLTI signal within an rTWT service period. In one approach, no STAs are allowed to transmit an LLTI signal within an rTWT service period. In another approach, STAs which support rTWT may need to terminate their TXOP acquired by LLTI-based channel access before the rTWT service period.

STAs with low latency traffic that successfully acquire the wireless medium through use of an LLTI signal may need to have a limited TXOP duration. For example, the TXOP duration may be limited to a time T (where T can be expressed in units of microseconds, milliseconds, TUs, etc.) In representative embodiments, the value of T may be predefined or it may be indicated by the AP in a Beacon frame, Probe Response frame, (Re) Association Response frame, or other management/control frame. The time T can be indicated in the Maximum LLTI TXOP Duration field 320, described above with reference to FIG. 3.

STAs may be allowed to transmit an LLTI signal at the beginning of a contention period, or they may be allowed to transmit the LLTI signal within TXOPs initiated by an AP. In the second case, the AP may transmit an initial control frame or an initial frame to start a TXOP. In the initial frame, the AP may indicate if an LLTI signal is allowed in the TXOP. In the initial frame, the AP may set the Duration field in the MAC header to cover the full TXOP duration. Or STAs may be allowed to transmit the LLTI signal within a TXOP (e.g., initiated by an AP) whose duration is greater than a threshold T (specified in units of microseconds, milliseconds, TUs, etc.) The threshold T may be predefined or indicated by the AP in a Beacon frame, Probe Response frame, (Re) Association Response frame, or other management/control frame. The threshold T can be indicated in the TXOP Threshold field 330, described above with reference to FIG. 3.

In representative embodiments, a STA waking up from a power save or doze mode may need to wait for the reception of the LLTI-related information (e.g., the LLTI management element 300) before it may use the LLTI to acquire the channel.

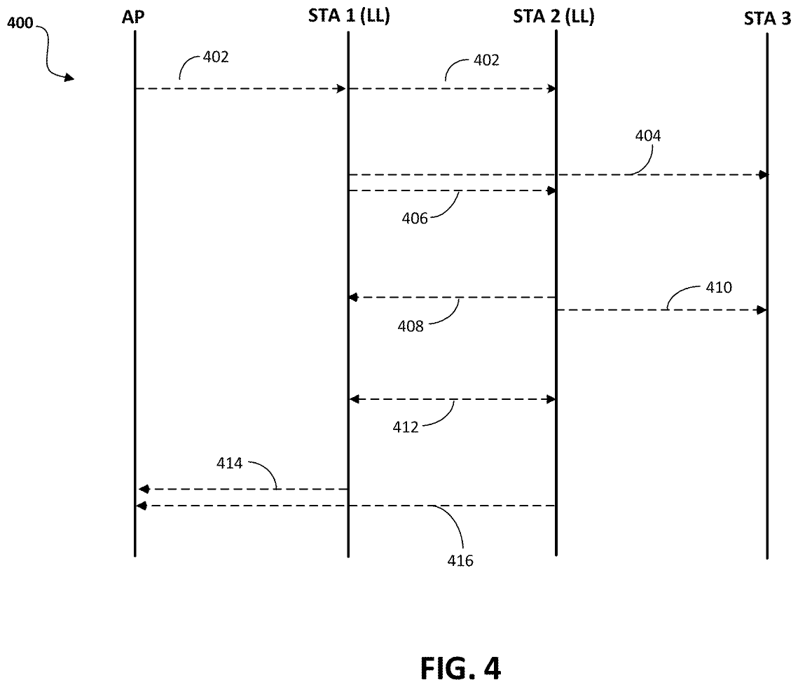

Referring now to FIG. 4, a messaging diagram illustrating an example method 400 in a WLAN, such as the example WLAN 200 of FIG. 2, is shown. The messaging diagram of FIG. 4 depicts an illustrative scenario involving the example WLAN, which includes an Access Point (AP) and three stations (STAs), STA 1-3. In the scenario depicted, STA 1 and STA 2 are capable of low latency traffic transmission, whereas STA 3 is not.

As depicted in FIG. 4, 402 represents the transmission from the AP of a broadcast signal (such as, for example, a Beacon frame) which conveys information related to the subsequent transmission of LLTI signals, such as described above, from those STAs capable of low latency traffic transmission. The broadcast signal of transmission 402 may contain an LLTI element, such as LLTI management element 300 described above with reference to FIG. 3. While said signal is broadcasted from the AP and thus can be received by all STAs in the WLAN, for purposes of this description, the transmission 402 of the signal is shown in FIG. 4 as being only to those STAs, in this case STA 1 and STA 2, which are capable of low latency traffic transmission and thus for which the LLTI-related information conveyed by the signal is relevant.

As represented by transmissions 404 and 406, STA 1, which has low latency traffic to transmit, transmits an LLTI signal, i.e., an LLTI-conveying control, management, or action frame (e.g., trigger frame, probe request, etc., such as represented by LLTI frame 204 shown in FIG. 2) to the other STAs (STA 2 and STA 3), thereby indicating its desire to transmit its low latency traffic on the wireless medium and for the other STAs to defer any transmissions of traffic on the wireless medium that those STAs may seek to perform.

Similarly, as represented by transmissions 408 and 410, STA 2, which has low latency traffic to transmit, also transmits an LLTI signal to the other STAs (STA1 and STA3), thereby indicating its desire to transmit its low latency traffic on the wireless medium and for the other STAs to defer any transmissions of traffic on the wireless medium that those STAs may seek to perform.

As depicted in FIG. 4, while STA 3 defers its transmission in response to receiving the LLTI signals from STAs 1 and 2, STAs 1 and 2 will contend for the medium based on the LLTI-related information (in e.g., LLTI management element 300) received from the AP in broadcast transmission 402. Contention processing, such as described herein, involving STAs 1 and 2 is then carried out, which may entail one or more transmissions 412 of signals from STAs 1 and 2.

Based on the contention processing, the STAs with low latency data will, in turn, transmit their data on the wireless medium, as represented by transmissions 414 and 416. The order of transmissions 414 and 416 will depend on the contention processing results; i.e., STA 1 may gain access to the medium before STA 2, or STA 2 may gain access to the medium before STA 1. Moreover, each transmission 414 or 416 may represent multiple transmissions.

While this disclosure refers to “low latency traffic,” the methods and apparatuses disclosed herein are not limited to low latency traffic, but may also be implemented for other types of high priority traffic, traffic for which it may be necessary or desirable to provide high priority transmission, or transmission of a higher priority than non-high priority traffic. As such for example, an indication such as the LLTI described above that can be used for high priority traffic may be referred to as a high priority traffic indication (HPTI) or an indication of high priority traffic, containing some or all of the same information or equivalents thereof as the LLTI.

Various numeric values are used in the present disclosure. The specific values are for example purposes and the aspects described are not limited to these specific values.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc. Use of such terms does not imply an ordering to the modified operations unless specifically required. So, in this example, a first operation need not be performed before a second operation, and may occur, for example, before, during, or in an overlapping time period with the second operation.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information may include one or more of, for example, estimating the information, calculating the information, predicting the information, or retrieving the information from memory.

Further, this disclosure may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

Although the features and elements of the present invention are described in the preferred embodiments in particular combinations, each feature or element can be used alone without the other features and elements of the preferred embodiments or in various combinations with or without other features and elements of the present invention. Although the solutions described herein consider 802.11 specific protocols, it is understood that the solutions described herein are not restricted to this specific implementation and are applicable to other wireless systems as well.

Although SIFS may be used to indicate various inter frame spacing in the examples of the designs and procedures, all other inter frame spacing such as RIFS, AIFS, DIFS or other agreed time interval could be applied in the same solutions. A Long Training Field (LTF) may be any type of predefined sequences that are known at both transmitter and receiver sides.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for a station (STA), the method comprising:
receiving, from an AP, a first frame including management information relating to one or more conditions for managing transmission of high priority traffic over a wireless medium in a Wireless Local Area Network (WLAN);
transmitting a second frame based on the management information; and
transmitting high priority traffic over the wireless medium.

2. The method of claim 1 comprising performing a backoff procedure if it is determined that a transmission over the wireless medium during a backoff period following the transmission of the second frame has occurred.

3. The method of claim 1 or 2, wherein the management information includes:
identification information identifying the management information as pertaining to high priority traffic; and
one or more of:
mode information, the mode information indicating one or more modes in which the second frame may be transmitted,
second frame transmission interval information,
backoff information,
transmission opportunity information,
priority information, or
length information, the length information indicating a length of the management information.

4. The method of claim 3, wherein the second frame transmission interval information includes at least one of a maximum number of second frame transmissions per beacon interval, or a minimum interval between second frame transmissions.

5. The method of claim 3, wherein the backoff information includes at least one of a minimum backoff counter value or a maximum backoff counter value.

6. The method of claim 3, wherein the transmission opportunity information includes at least one of a maximum number of second frame transmissions per transmission opportunity, a maximum transmission opportunity duration, or a transmission opportunity threshold.

7. The method of claim 3, wherein the priority information includes at least one of a retry allowance information, a delay bound information, a periodic low latency traffic allowance information, or a user priority information.

8. The method of claim 1, wherein the management information is transmitted in one or more of a frame, an element, a field, or a subfield.

9. The method of claim 1, wherein the high priority traffic includes low latency traffic.

10. A station (STA) comprising:
a transceiver and a processor communicatively coupled to the transceiver, the transceiver and processor configured to:
receive, from an AP, a first frame including management information relating to one or more conditions for managing transmission of high priority traffic over a wireless medium in a Wireless Local Area Network (WLAN);
transmit a second frame based on the management information; and
transmit high priority traffic over the wireless medium.

11. The STA of claim 10, wherein the transceiver and processor are configured to perform a backoff procedure if it is determined that a transmission over the wireless medium during a backoff period following the transmission of the second frame has occurred.

12. The STA of claim 10, wherein the management information includes:
identification information identifying the management information as pertaining to high priority traffic; and
one or more of:
mode information, the mode information indicating one or more modes in which the second frame may be transmitted,
second frame transmission interval information,
backoff information,
transmission opportunity information,
priority information, or
length information, the length information indicating a length of the management information.

13. The STA of claim 12, wherein the second frame transmission interval information includes at least one of a maximum number of second frame transmissions per beacon interval, or a minimum interval between second frame transmissions.

14. The STA of claim 12, wherein the backoff information includes at least one of a minimum backoff counter value or a maximum backoff counter value.

15. The STA of claim 12, wherein the transmission opportunity information includes at least one of a maximum number of second frame transmissions per transmission opportunity, a maximum transmission opportunity duration, or a transmission opportunity threshold.

16. The STA of claim 12, wherein the priority information includes at least one of a retry allowance information, a delay bound information, a periodic low latency traffic allowance information, or a user priority information.

17. The STA of claim 10, wherein the management information is transmitted in one or more of a frame, an element, a field, or a subfield.

18. The STA of claim 10, wherein the high priority traffic includes low latency traffic.

19. A method for an access point, the method comprising:
transmitting to a station management information relating to one or more conditions for managing transmission of high priority traffic over a wireless medium in a Wireless Local Area Network;
receiving from the STA a second frame based on the management information; and
receiving high priority traffic over the wireless medium.

20. The method of claim 19, wherein the management information includes:
identification information identifying the management information as pertaining to high priority traffic; and
one or more of:
mode information, the mode information indicating one or more modes in which the second frame may be transmitted,
second frame transmission interval information,
backoff information,
transmission opportunity information,
priority information, or
length information, the length information indicating a length of the management information.

21. The method of claim 20, wherein the second frame transmission interval information includes at least one of a maximum number of second frame transmissions per beacon interval, or a minimum interval between second frame transmissions.

22. The method of claim 20, wherein the backoff information includes at least one of a minimum backoff counter value or a maximum backoff counter value.

23. The method of claim 20, wherein the transmission opportunity information includes at least one of a maximum number of second frame transmissions per transmission opportunity, a maximum transmission opportunity duration, or a transmission opportunity threshold.

24. The method of claim 20, wherein the priority information includes at least one of a retry allowance information, a delay bound information, a periodic low latency traffic allowance information, or a user priority information.

25. The method of claim 19, wherein the management information is transmitted in one or more of a frame, an element, a field, or a subfield.

26. The method of claim 19, wherein the high priority traffic includes low latency traffic.
